(19) United States
(12) Patent Application Publication
(10) Pub. No.: US 2004/0113437 A1
(43) Pub. Date: Jun. 17, 2004

(54) Door lock device

(75) Inventors: Shigeru Hayakawa, Chiryu-shi (JP); Makoto Suzumura, Chita-shi (JP); Akira Muramatsu, Chiryu-shi (JP); Katsutoshi Fukunaga, Chiryu-shi (JP); Kan Ichihara, Kariya-shi (JP); Yukinobu Kunimatsu, Aichi-ken (JP)

Correspondence Address: BURNS DOANE SWECKER & MATHIS L L P, POST OFFICE BOX 1404, ALEXANDRIA, VA, 22313-1404, US

(73) Assignee: AISIN SEIKI KABUSHIKI KAISHA

(21) Appl. No.: 10/686,671

(22) Filed: Oct. 17, 2003

(30) Foreign Application Priority Data
Oct. 18, 2002 (JP) 2002-304643

(51) Int. Cl. E05C 3/06

(52) U.S. Cl. 292/201

(57) ABSTRACT

A door lock device includes a latch mechanism provided at a vehicle door and engageable with or disengageable from a striker provided at a vehicle body, a lift lever for operating the latch mechanism from an engaged state to a disengaged state by engaging with or disengaging from the striker, an open lever movable from an initial position to an operating position by operation of a door opening member provided at the vehicle door, and a lock lever movable between an unlocked position and a locked position by operation of a door locking/unlocking member provided at the vehicle door. The door lock device further includes an open member and a biasing member. The open member is movable between the unlocked position in which the open member engages with the lift lever by movement of the open lever in one direction thereby allowing the lift lever operable and the locked position in which the open member idly engages with the lift lever by movement of the open lever and then becomes engaged with the lift lever in the other direction thereby prohibiting the lift lever operable when the open member is switched to the unlocked position from the locked position. The biasing member biases the open member from the locked position to the unlocked position. When the lock lever is moved from the unlocked position to the locked position, the open member is moved from the unlocked position to the locked position with the lock lever engaging with the open member, and when the lock lever is moved from the locked position to the unlocked position, the open member can relatively movable to the lock lever.

### CROSS REFERENCE TO RELATED APPLICATIONS

The application is based on and claims priority under 35 U.S.C. § 119 with respect to a Japanese Patent Application 2002-304643, filed on Oct. 18, 2002, the entire content of which is incorporated herein by reference.

### FIELD OF THE INVENTION

This invention generally relates to a door lock device. More particularly, this invention pertains to a door lock device applied to a vehicle door.

### BACKGROUND OF THE INVENTION

A known door lock device includes a latch mechanism provided at a vehicle door and engageable with or disengageable from a striker provided at a vehicle body, a lift lever for operating the latch mechanism from an engaged state to a disengaged state by engaging with or disengaging from the striker, an open lever movable from an initial position to an operating position by operation of a door opening member provided at the vehicle door, and a lock lever movable between an unlocked position and a locked position by operation of a door locking/unlocking member provided at the vehicle door. The door lock device further includes an open member connected to the lock lever and movable between the unlocked position and the locked position. When the open member is in the unlocked position, the open member engages with the lift lever by movement of the open lever in one direction, thereby allowing the lift lever operable. When the open member is in the locked position, the open member idly engages with the lift lever by movement of the open lever and then becomes engaged with the lift lever in the other direction, thereby prohibiting the lift lever operable when the open member is switched to the unlocked position from the locked position.

According to the known device, an unlocked state is defined when the open member is in the unlocked position while a locked state is defined when the open member is in the locked position. In the unlocked state, the open member is operated with the lift lever by engaging therewith due to the operation of a door handle and the like whereby the latch mechanism disengages from the striker. In the locked state, the open member idly engages with the lift lever and thus the lift lever is not operated even if the door handle is operated. The latch mechanism cannot disengage from the striker accordingly.

When the door handle and the door locking/unlocking member such as a door lock knob are operated at substantially the same time in the locked state, the aforementioned device is known to cause a problem as follows. When the door handle is operated before the operation of the door lock knob, the open member idly engages with the lift lever and then moved in a direction of the unlocked position. In this case, since the open member engages with the lift lever in the other direction, movement of the open member is restricted, and then the lock lever cannot be moved to the unlocked position. Thus, when the door handle is returned to a normal position from a pulled position, the door lock knob remains in the locked position even though the door lock knob is once operated to be unlocked (which is called a panic state). It is required to operate the door lock knob again to switch to the unlocked state, which takes a lot of trouble. This kind of trouble may occur in a door lock system for automatically switching to the unlocked state from the locked state by detecting an approach of the user's hand to the door handle. The door handle can be operated before the automatic switching to the unlocked state is performed depending on control timing.

A device disclosed in a Japanese Patent Laid-Open Publication No. 11(1999)-166337 is known to solve the above-mentioned problem. FIG. 10 shows a structure of the disclosed device. The disclosed device includes a lift lever 100 for operating the latch mechanism from the engaged state to the disengaged state by engaging with or disengaging from the striker provided at the vehicle body, an open lever 101 movable from the initial position to the operating position by the operation of the door handle provided at the vehicle door, and a lock lever 102 provided at the vehicle door and operated by the operation of the door lock knob and the like. The disclosed device further includes an open link 103 connected to the lock lever 102 and movable between the unlocked position and the locked position. The open link 103 engages with the lift lever 100 in S direction by movement of the open lever 101 from the initial position to the operating position, thereby allowing the lift lever 100 operable when the open link 103 is in the unlocked position. The open link 103 also idly engages with the lift lever 100 in the locked position. The open link 103 includes a main link 103a connected to the open lever 101 and the lock lever 102, and a sub link 103b mounted on the main link 103a via a pin 104 so that the sub link 103b relatively rotates to the main link 103a and engageable with the lift lever 100. FIG. 10 shows the locked state in which the sub link 103b idly engages with the lift lever 100.

The aforementioned disclosed device is operated as follows in the locked state when the door handle and the door lock knob are operated substantially at the same time. The open link 103 is moved in substantially S direction while idly engaging with the lift lever 100 by the operation of the door handle. Then, the open link 103 is moved in T direction, i.e. unlocked position, by the operation of the door lock knob. In this case, the sub link 103b engages with the lift lever 100 and relatively rotates to the main link 103a. The main link 103a of the open link 103 is therefore moved to the unlocked position together with the lock lever 102. When the door handle is returned to the normal position, the open lever 101 is moved from the operating position to the initial position by a spring 106, and the sub link 103b relatively rotates to the main link 103a by biasing force of a spring 105. Then, the open link 103 as a whole is returned to the unlocked initial position (i.e. recovered from the panic state). It is thus not required to operate the door lock knob again.

However, the above-mentioned device have a following problem. The open link 103 consists of the main link 103a and the sub link 103b. Further, the spring 105 is provided between the main link 103a and the sub link 103b, and then the sub link 103b is biased in a predetermined direction (in a counterclockwise direction). That is, the number of parts included in this device is increased in order to prevent the panic state, the structure of the device becomes complicated, and then a lot of trouble is taken with assembling.

The present invention therefore seeks to provide a door lock device in which operation for switching to an unlocked state does not require to be performed again even if a door opening member and a door locking/unlocking member are operated at substantially the same time in a locked state without complicating a structure.

### SUMMARY OF THE INVENTION

According to an aspect of the present invention, a door lock device includes a latch mechanism provided at a vehicle door and engageable with or disengageable from a striker provided at a vehicle body, a lift lever for operating the latch mechanism from an engaged state to a disengaged state by engaging with or disengaging from the striker, an open lever movable from an initial position to an operating position by operation of a door opening member provided at the vehicle door, and a lock lever movable between an unlocked position and a locked position by operation of a door locking/unlocking member provided at the vehicle door. The door lock device further includes an open member and a biasing member. The open member is movable between the unlocked position in which the open member engages with the lift lever by movement of the open lever in one direction thereby allowing the lift lever operable and the locked position in which the open member idly engages with the lift lever by movement of the open lever and then becomes engaged with the lift lever in the other direction thereby prohibiting the lift lever operable when the open member is switched to the unlocked position from the locked position. The biasing member biases the open member from the locked position to the unlocked position. When the lock lever is moved from the unlocked position to the locked position, the open member is moved from the unlocked position to the locked position with the lock lever engaging with the open member, and when the lock lever is moved from the locked position to the unlocked position, the open member can relatively movable to the lock lever.

According to another aspect of the present invention, the biasing member biases the open lever to the initial position from the operating position.

According to another aspect of the present invention, the door lock device further includes a base. The open lever is rotatably supported by a first rotational center relative to the base, the open member is rotatably supported by a second rotational center relative to the open lever, and the biasing member is a torsion spring supported by the first rotational center, in which one end is engaged with the base and the other end is engaged with an engaging portion provided on the open member so as to be located differently from the second rotational center.

According to another aspect of the present invention, the lock lever includes a guide arm. The guide arm is connected to the link member and the lock lever in order to when the lock lever is moved from the locked position to the unlocked position.

According to another aspect of the present invention, the open member includes a link member and an elastic member. The link member receives an operation force from the open lever and engageable with the lift lever. The elastic member is connected with the link member and the lock lever in order to when the lock lever is moved from the locked position to the unlocked position.

### BRIEF DESCRIPTION OF THE DRAWING FIGURES

The foregoing and additional features and characteristics of the present invention will become more apparent from the following detailed description considered with reference to the accompanying drawing figures wherein:

FIG. 1 is a plane view of a latch mechanism of a door lock device according to first embodiment of the present invention;

FIG. 2 is a plane view of a lock mechanism of the door lock device according to the first embodiment of the present invention;

FIG. 3 is a lateral view of the lock mechanism of the door lock device according to the first embodiment of the present invention;

FIG. 4 is a plane view showing an unlocked state of the door lock device according to the first embodiment of the present invention;

FIG. 5 is a plane view of the door lock device in which a door opening member is operated in a state shown in FIG. 4;

FIG. 6 is a plane view showing a locked state of the lock mechanism of the door lock device according to the first embodiment of the present invention;

FIG. 7 is a plane view of the door lock device in which the door opening member is operated in a state shown in FIG. 6;

FIG. 8 is a plane view of the door lock device in which unlocking operation for switching to the unlocked state is performed in a state shown in FIG. 7;

FIG. 9 is a plane view of the door lock device in which unlocking operation for switching to the unlocked state of the lock mechanism of the door lock device and door opening member is operated according to the second embodiment of the present invention; and

FIG. 10 is a plane view of a known door lock device.

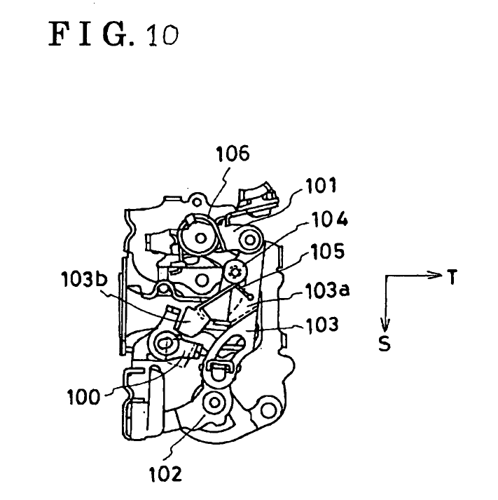

### DETAILED DESCRIPTION OF THE INVENTION

Hereinafter, an embodiment of the present invention is described with reference to attached drawings. In each drawing, a vehicle frontward direction, a vehicle rearward direction, a vehicle inboard direction, a vehicle outboard direction, a vehicle upward direction, and a vehicle downward direction are represented by F, R, I, O, U, and D respectively using arrows.

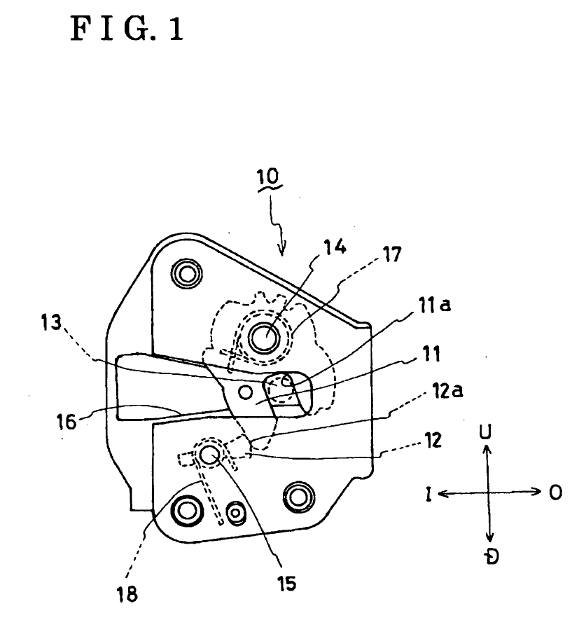

First, a latch mechanism of a door lock device 10 is explained with reference to FIG. 1. The door lock device 10 is provided at a vehicle door (not shown) and including a latch 11 (a latch mechanism) and a pawl 12 (a latch mechanism). The latch 11 includes a receiving groove 11a for receiving and capturing a striker 13 (a striker) therein provided at a vehicle body (not shown). The pawl 12 includes a contacting portion 12a in contact with the latch 11, restricting rotation of the latch 11. The latch 11 and the pawl 12 are connected to shafts 14 and 15 of the door lock device 10 respectively, being rotatable together with the shafts 14 and 15 respectively.

An operation of the latch mechanism of the door lock device 10 is explained as follows. FIG. 1 shows a latched state (an engaged state) in which the latch 11 captures the striker 13. In the latched state, the vehicle door is held at the vehicle body, i.e. door closing held state. When the latch 11 rotates in a clockwise direction in FIG. 1 by a predetermined angle from the latched state, the receiving groove 11 a becomes parallel with a notch 16 formed on the vehicle door, and then the striker 13 is disengageable from the latch 11 in a leftward direction in FIG. 1, which is an unlatched state (a disengaged state). Thus, the vehicle door can be opened relative to the vehicle body. The latch 11 is biased in the clockwise direction in FIG. 1 by a spring 17 provided around the shaft 14. As described above, the pawl 12 restricts the rotation of the latch 11 via the connecting portion 12a in the latched state. When the pawl 12 rotates in the clockwise direction in FIG. 1 by a predetermined angle, the contacting portion 12a disengages from the latch 11, and then the latch 11 rotates up to the unlatched state. The latch 11 can be operated by the pawl 12 to engage with or disengage from the latch 11. The pawl 12 is also biased in a counterclockwise direction in FIG. 1 by a spring 18 provided around the shaft 15. The latch 11 is engageable with or disengageable from the striker 13 accordingly.

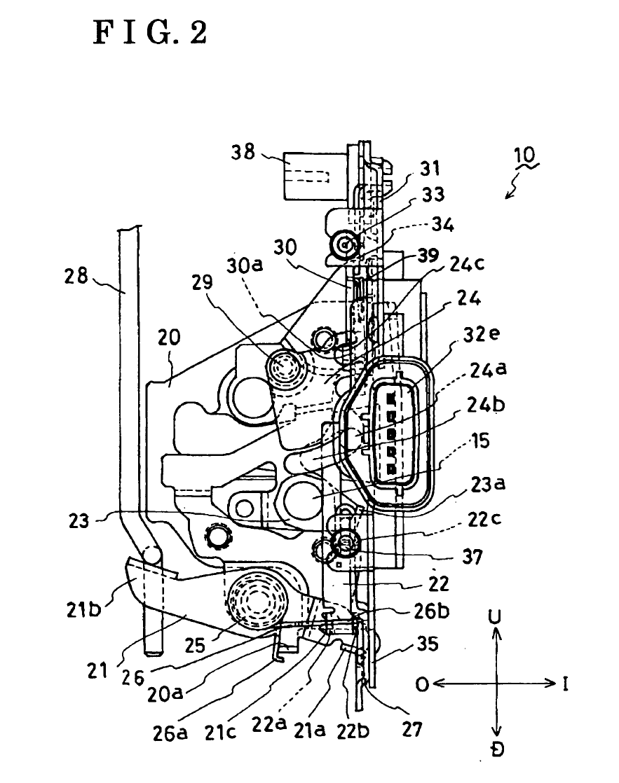

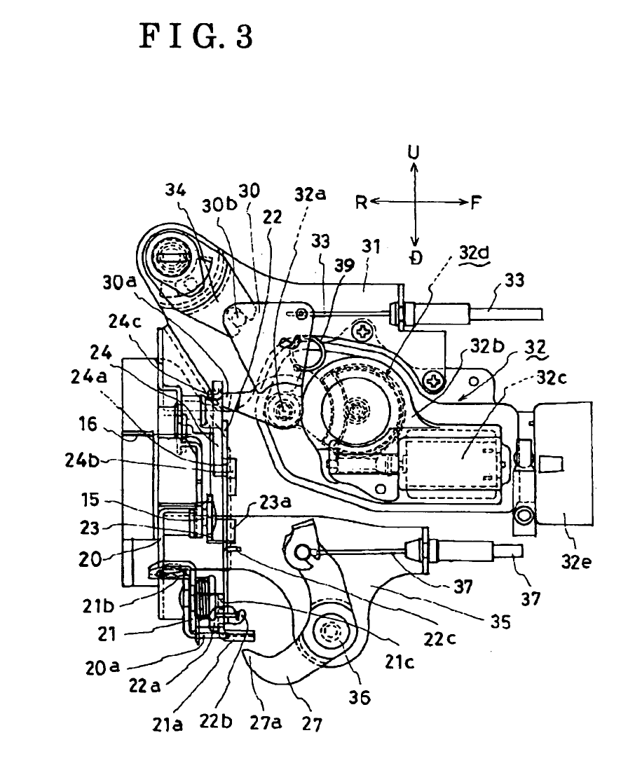

A lock mechanism of the door lock device 10 is explained with reference to FIGS. 2 and 3. The lock mechanism of the door lock device 10 substantially includes an opening operation member and a locking operation member. The opening operation member actuates the latch 11 to open the vehicle door relative to the vehicle body in response to operation of an outside handle (a door opening member) (not shown) provided at the outboard side of the vehicle door or an inside handle (a door opening member) (not shown) provided at the inboard side of the vehicle door. The locking operation member switches an unlocked state in which the latch 11 can be operated and a locked state in which the latch 11 cannot be operated therebetween by the operation of the outside handle and the like in response to operation of a key cylinder 38 (a door locking/unlocking member) or a door lock knob (a door locking/unlocking member) (not shown).

As shown in FIG. 2, the opening operation member includes an open lever 21 (an open lever), an open link 22 (an open member), and a lift lever 23 (a lift lever) provided on a base 20 (a base).

The open lever 21 is rotatably connected to the base 20 via a pin 25 (a first rotational center) provided at a substantially middle portion of the open lever 21 in a longitudinal direction thereof. The open lever 21 is provided with a torsion spring 26 (a biasing member, a torsion spring). The torsion spring 26 is fixed to the pin 25. An end portion 26a (one end) of the torsion spring 26 is engaged with an engaging flange 20a formed on the base 20, and an end portion 26b (the other end) is engaged with an engaging flange 22b (an engaging portion) of the open link 22 (say later). The open lever 21 is biased in a clockwise direction in FIG. 2 by the torsion spring 26. The open lever 21 contacts the flange 20a, which restricts rotation of the open lever 21 in the clockwise direction in FIG. 2. Details about the torsion spring 26 is described later. The open lever 21 includes an engaging end portion 21a at a right end in FIG. 2. The engaging end portion 21a receives an input from an inside lever 27 via an end 27a, as shown in FIG. 3. The inside lever 27 is rotatably supported by a vertical base 35 via a pin 36. The vertical base 35 is provided so as to be perpendicular to the base 20. The inside lever 27 is connected to the inside handle provided at the inboard side of the vehicle door via a cable 37. When the inside handle is operated, the inside lever 27 rotates in a clockwise direction in FIG. 3, and the end 27a of the inside lever 27 pushes the engaging end portion 21a of the open lever 21 in the upward direction. Then, the open lever 21 rotates in a counterclockwise direction in FIG. 2 by a predetermined angle with respect to the pin 25.

The open lever 21 also includes a connecting end portion 21b on an opposite side to the engaging end portion 21a with respect to the pin 25. The connecting end portion 21b is connected to a rod 28 connected to the outside handle provided at the outboard side of the vehicle door. That is, the open lever 21 also rotates in the counterclockwise direction in FIG. 2 by a predetermined angle with respect to the pin 25 by the operation of the outside handle.

The open lever 21 further includes a connecting hole 21c (a second rotational center) between the engaging end portion 21a and the pin 25. The connecting hole 21c has a shape with approximately figure of eight and engaged with a connecting detent portion 22a (a second rotational center) of the open link 22 (say later).

The open link 22 extends in the upward and downward direction in FIG. 2. The open link 22 includes the connecting detent portion 22a, the engaging flange 22b, and an engaging flange 22c. The connecting detent portion 22aextends in a leftward direction in FIG. 3 so as to be flanged shape. As described above, the connecting detent portion 22a is engaged with the connecting hole 21c of the open lever 21, and then the open link 22 is connected to the open lever 21 so as to rotate in the clockwise and counterclockwise direction in FIG. 2 relative to the open lever 21 by a predetermined angle. The open link 22 is moved in the approximately upward and downward direction in FIG. 2 when the open lever 21 is rotated with respect to the pin 25.

The engaging flange 22b extends in a rightward direction in FIG. 3. As apparently shown in FIG. 2, the engaging flange 22b is located in a rightward direction in FIG. 2 from the connecting hole 21 c. That is, the engaging flange 22bis provided so as to be located differently from the connecting hole 21c. The engaging flange 22b is engaged with the end portion 26b of the torsion spring 26, as described above. Biasing force of the torsion spring 26 is inputted to the open link 22 via the end portion 26b and then acts on the open lever 21 via the connecting detent portion 22a and the connecting hole 21c.

The engaging flange 22c is provided at a substantially middle portion of the open link 22 in a longitudinal direction thereof and extends in a rightward direction in FIG. 3. The engaging flange 22c is located below the lift lever 23 in FIG. 3. An upper side of the open link 22 contacts a locking lever 24 (say later)

The lift lever 23 is rotatably connected to the shaft 15 to which the pawl 12 is rotatably connected. The lift lever 23 is formed with a flange 23a extending in the vehicle frontward direction. When the engaging flange 22c of the open link 22 contacts the flange 23a in an upward direction in FIG. 3 (a one direction), the lift lever 23 rotates in the counterclockwise direction in FIG. 2 with respect to the shaft 15. That is, the pawl 12 rotates in the clockwise direction in FIG. 1 when the lift lever 23 rotates in the counterclockwise direction in FIG. 2, and then the latch 11 is switched from the latched state to the unlatched state.

The locking operation member of the door lock device 10 includes the locking lever 24 (a lock lever) and the like. As shown in FIGS. 2 and 3, the locking lever 24 is rotatably connected to the base 20 via a pin 29. The locking lever 24 includes a connecting shaft 24a, a guide arm 24b, and a connecting notch 24c. The connecting shaft 24a is formed so as to extend in the rightward direction in FIG. 3 from a main part of the locking lever 24 and has cylindrical shape. The guide arm 24b extends from the main part of the locking lever 24 so as to be an approximately circular arc with respect to the pin 29. The open link 22 extends between the main part of the locking lever 24 and the guide arm 24b. When the locking lever 24 rotates in the clockwise direction in FIG. 2 with respect to the pin 29, the connecting shaft 24a contacts the open link 22 in a leftward direction in FIG. 2, and then the open link 22 is pushed.

As shown in FIG. 3, the connecting notch 24c of the locking lever 24 is connected to an output arm 30a of an intermediate lever 30. The intermediate lever 30 is rotatably connected to an output shaft 32a of a locking actuator 32. The locking actuator 32 is fixed to a vertical base 31 provided so as to be approximately perpendicular to the base 20. The locking actuator 32 houses a motor 32c, and a gear mechanism 32d within a case 32b and electrically connected to ECU (not shown) via a connector 32e. The ECU is provided in the vehicle body. This ECU transmits an operation signal to the locking actuator 32 responding to a signal from a door lock/unlock switch (a door locking/unlocking member) (not shown) provided in the vehicle, a keyless entry switch (a door locking/unlocking member) (not shown) provided in the key, a human body detecting system (referred to as a smart key entry system) including a capacitance sensor (a door locking/unlocking member) (not shown) provided near the outside handle, or a pressing type switch (a door locking/unlocking switch), if provided, at the outside handle. According to the above-mentioned structure, the locking actuator 32 rotates the intermediate lever 30 with respect to the output shaft 32a in response to the signal from the capacitance sensor and the like. In this case, the locking lever 24 is rotated relative to the base 20 with respect to the pin 29.

As shown in FIG. 3, the intermediate lever 30 is connected to the door lock knob (not shown) provided at the inside of the vehicle door via a cable 33. Further, the intermediate lever 30 is connected to the key cylinder 38 provided at the outside of the vehicle door via a connecting pin 30b and a key lever 34. That is, the intermediate lever 30 is rotated with respect to the output shaft 32a by the operation of the door lock knob or the key cylinder 38.

As shown in FIG. 3, a turnover spring 39 is provided between the intermediate lever 30 and the locking actuator 32. The intermediate lever 30 is biased by biasing force of the turnover spring 39 acting on the intermediate lever 30 and restricted so as to be selectively switched between the locked state and the unlocked state of the door lock device 10, as described later.

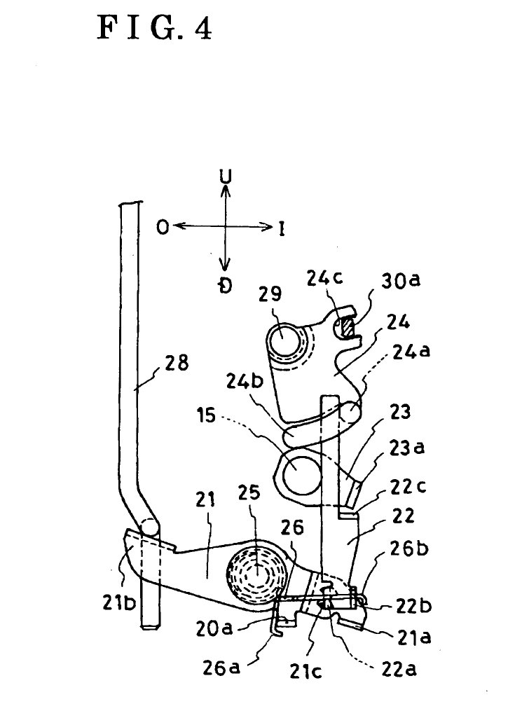

Operation of the door lock device 10 is explained with reference to FIGS. 4-8. In FIGS. 4-8, operations of the open lever 21, the open link 22, the lift lever 23, and the locking lever 24 are shown.

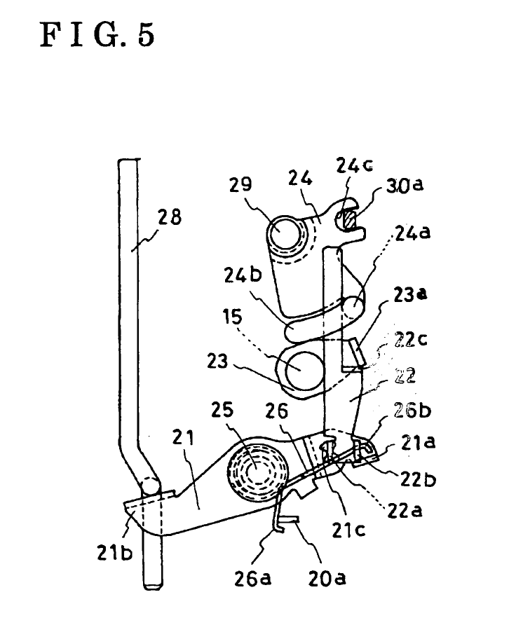

An operation for opening the vehicle door by the outside handle and the like is explained as follows. FIG. 4 shows the unlocked state of the door lock device 10. In the unlocked state, the locking lever 24 is in an unlocked position as shown, and the open link 22 is in the unlocked position in which the engaging flange 22c of the open link 22 is located below the flange 23a of the lift lever 23. In FIG. 4, the open lever 21 is in an initial position in which the operation of the outside handle does not acts on the open lever 21. When the vehicle door is operated to open via the outside handle in this state, the open lever 21 rotates in a counterclockwise direction in FIG. 4 by a predetermined angle and then moved to an operating position shown in FIG. 5. In this case, the open link 22 is moved upward, the engaging flange 22c of the open link 22 contacts the flange 23a of the lift lever 23 in the upward direction (one direction) as shown in FIG. 5, and the flange 23a is pushed upward. Then, the lift lever 23 is rotated in a counterclockwise direction in FIG. 5 with respect to the shaft 15. Accordingly, the door lock device 10 is switched to the unlatched state.

An operation for switching the unlocked state and the locked state therebetween of the door lock device 10 by the locking actuator 32 is explained as follows. The locked state means a state in which the vehicle door cannot be opened by the operation of the outside handle and the like (i.e. the latch 11 cannot be switched from the latched state to the unlatched state).

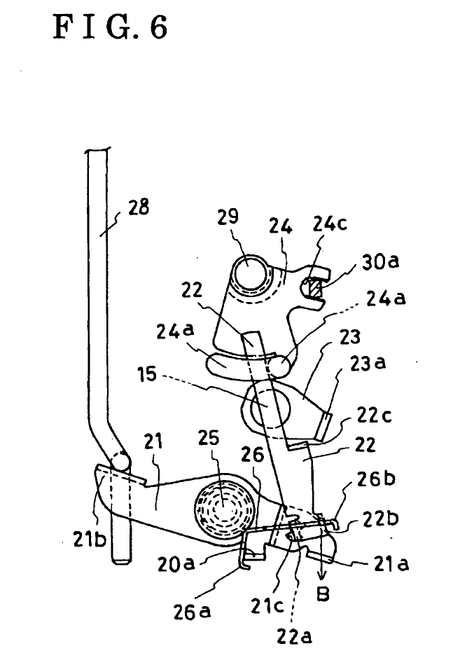

In the unlocked state shown in FIG. 4, when the locking operation (i.e. switching to the locked state) is performed by actuation of the locking actuator 32 for example, the intermediate lever 30 rotates in a counterclockwise direction in FIG. 3 by a predetermined angle with respect to the output shaft 32a. Then, the locking lever 24 rotates in a clockwise direction in FIG. 4 by a predetermined angle with respect to the pin 29. In this case, the connecting shaft 24a contacts the open link 22 in a leftward direction in FIG. 4, and the open link 22 is pushed. Then, the open link 22 rotates in the counterclockwise direction in FIG. 4 by a predetermined angle with respect to the connecting hole 21c (the connecting detent portion 22a) under the biasing force of the torsion spring 26, the open link 22 is moved to a locked position shown in FIG. 6. In FIG. 6, the locking lever 24 and the open link 22 are in the locked state in which the locking lever 24 and the open link 22 are in a locked position. In FIG. 6, the open link 22 is biased so as to rotate in a clockwise direction with respect to the connecting hole 21c (the connecting detent portion 22a) by the biasing force of the torsion spring 26, and further, the locking lever 24 and the intermediate lever 30 are biased so as to rotate in a counterclockwise direction in FIG. 6 and the clockwise direction in FIG. 3 respectively. However, the biasing force of the turnover spring 39 is set to be larger than that of the torsion spring 26, and the intermediate lever 30, the locking lever 24, and the open link 22 is not rotated by the biasing force of the torsion spring 26.

In the locked state shown in FIG. 6, when the unlocking operation (i.e. switching to the unlocked state) is performed by the locking actuator 32 for example, the intermediate lever 30 rotates in the clockwise direction in FIG. 3 by a predetermined angle with respect to the output shaft 32a regardless of the biasing force of the turnover spring 39. Then, the locking lever 24 rotates in the counterclockwise direction in FIG. 6 with respect to the pin 29, and the open link 22 is not pushed in the leftward direction by the connecting shaft 24a. In this case, the torsion spring 26 biases the engaging flange 22b of the open link 22 in B direction indicated by arrow. As described above, the engaging flange 22b is provided so as to be located differently from the connecting hole 21c corresponding to the rotational center of the open link 22, and the moment acts on the open link 22. Then, the open link 22 rotates in the clockwise direction in FIG. 6 with respect to the connecting hole 21c (the connecting detent portion 22a), and the locked state is switched to the unlocked state shown in FIG. 4.

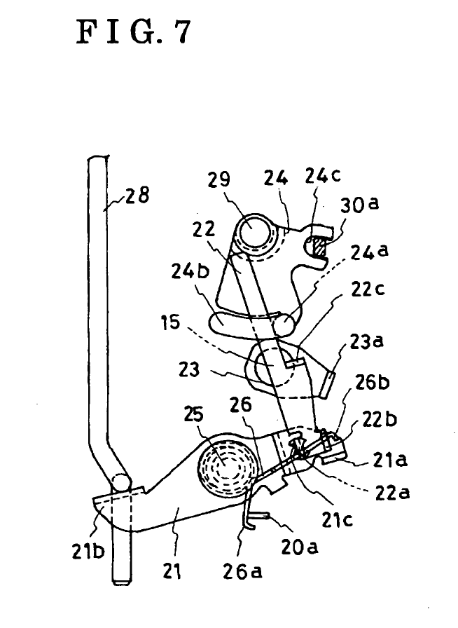

In the locked state, when the outside handle is operated (i.e. the vehicle door is operated to open), the open link 22 is moved in substantially upward direction as shown in FIG. 7. However, the engaging flange 22c idly engages with the flange 23a as shown in FIG. 7, which results in disengagement between the open link 22 and the lift lever 23. Thus, even if the vehicle door is operated to open in the locked state, the lift lever 23 is not operated, then the vehicle door is not switched to the unlatched state.

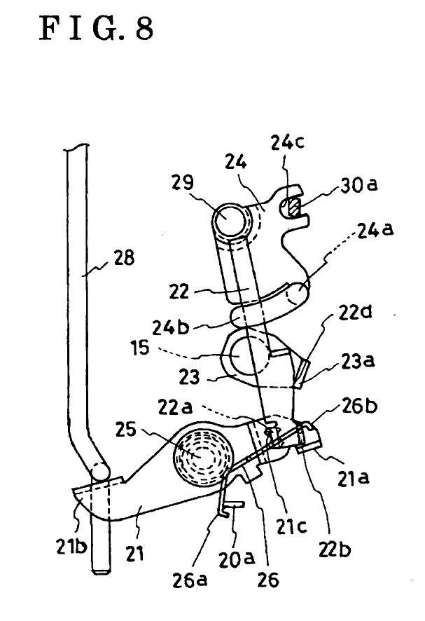

When the unlocking operation (i.e. switching to the unlocked state) is performed in the state shown in FIG. 7 by the locking actuator 32 for example, the locking lever 24 rotates in the counterclockwise direction in FIG. 6 with respect to the pin 29, and as described above, the open link 22 rotates in a clockwise direction in FIG. 7 with respect to the connecting hole 21c (the connecting detent portion .22a). Then, a lateral portion 22d extending downward from the engaging flange 22c of the open link 22 contacts the flange 23a of the lift lever 23 in a rightward direction (the other direction) as shown in FIG. 8, and the open link 22 cannot be moved in the rightward direction any more. However, the connecting shaft 24a of the locking lever 24 can disengage from the open link 22, then the locking lever 24 can be moved to the unlocked position independently of the open link 22.

In FIG. 8, when the outside handle is returned, the biasing force of the torsion spring 26 acts on the open lever 21 via the open link 22, and the open lever 22 rotates in a clockwise direction in FIG. 8. Then, the open link 22 is moved downward, and the lateral portion 22d of the open link 22 disengages from the flange 23a of the lift lever 23. At the same time, since the biasing force of the torsion spring 26 acts on the open link 22, the open link 22 rotates in the clockwise direction in FIG. 8 with respect to the connecting hole 21c (the connecting detent portion 22a). In this case, the open link 22 is guided between the main part and the guide arm 24b of the locking lever 24, and then the rotation of the open link 22 can be stable. According to the foregoing operation, the door lock device 10 is switched to the unlocked state.

As explained above, even if the outside handle and the locking actuator 32 are operated substantially at the same in the locked state, the door lock device 10 is switched to the unlocked state when the outside handle is returned. Consequently, the operation for switching to the unlocked state does not require to be performed again, and thus trouble with the operation can be saved.

According to the embodiment, the locking lever 24 can disengage from the open link 22, the torsion spring 26 biases the open link 22 so as to be located at the unlocked position as well as the open lever 21 so as to be located at the initial position, which saves the trouble with the operation. That is, the number of the parts of the door lock device 10 does not increase by using the parts generally included in the known door lock device, the structure of the door lock device 10 does not become complicated, which is effective structure from the viewpoint of assembling work.

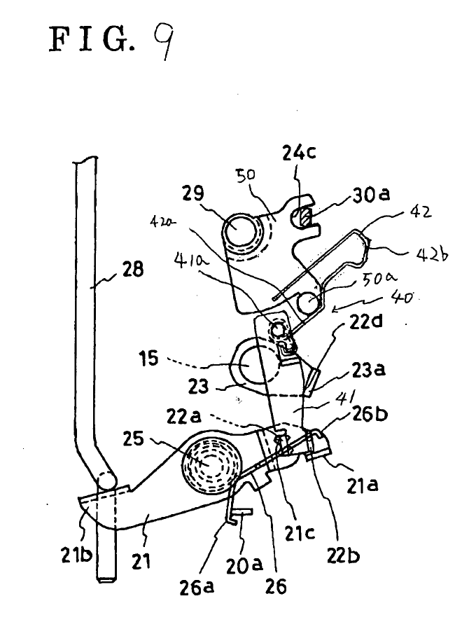

As shown in FIG. 9, an open link 40 includes an link member 41 and a spring 42. The link member 41 made of rigid metallic sheet includes the connecting detent portion 22a, the engaging flange 22b and the engaging flange 22c. The link member 41 further include a engaging pin 41a. One end 42a of the spring 42 is engaged with the link member 41. The spring 42 is wound around the engaging pin 41a. A U-shaped portion 42b of the spring 42 extending in the upward direction of the vehicle is flexible so as to pivotally move with respect to the vicinity of the engaging pin 41a.

A locking lever 50 includes the connecting notch 24c. The locking lever 50 further include a connecting pin 50a. The connecting pin 50a of the locking lever 50 is positioned within a space defined by the U-shaped portion 42b of the spring 42, therefore, the open link 40 as a whole ( link member 41 and spring 42) is operated (i.e., rotates with respect to the connecting detent portion 22a) in accordance with the rotation of the lock lever 50.

In the lock state, when the outside handle is operated and when the unlock operation, the engaging flange 22c engages with the lift lever 23 in the rightward direction in FIG. 9, thereby prohibiting the lift lever 23 from operating. The open link 40 is thus restricted to move. In this case, however, the spring 42 is flexibly moved with respect to the vicinity of the engaging pin 41a, thereby shifting the locking lever 50 to the unlocked position. In case that the outside handle is returned to the normal position form a state shown FIG. 9, the open link 40 is moved downward in FIG. 9 whereby the engagement between the engaging flange 22c and the lift lever 23 is released. The link member 41 rotates with a predetermined amount with respect to the connecting detent portion 22a due to a biasing forces of the spring 42 and torsion spring 26. Then the unlocked state of the door lock device 10 is switched to the unlocked state.

The principles, preferred embodiments and mode of operation of the present invention have been described in the foregoing specification. However, the invention which is intended to be protected is not to be construed as limited to the particular embodiments disclosed. Further, the embodiments described herein is to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What we claim is:

1. A door lock device, comprising:
a latch mechanism provided at a vehicle door and engageable with or disengageable from a striker provided at a vehicle body;
a lift lever for operating the latch mechanism from an engaged state to a disengaged state by engaging with or disengaging from the striker;
an open lever movable from an initial position to an operating position by operation of a door opening member provided at the vehicle door;
a lock lever movable between an unlocked position and a locked position by operation of a door locking/unlocking member provided at the vehicle door;
an open member movable between the unlocked position in which the open member engages with the lift lever by movement of the open lever in one direction thereby allowing the lift lever operable and the locked position in which the open member idly engages with the lift lever by movement of the open lever and then becomes engaged with the lift lever in the other direction thereby prohibiting the lift lever operable when the open member is switched to the unlocked position from the locked position; and
a biasing member for biasing the open member from the locked position to the unlocked position;
wherein when the lock lever is moved from the unlocked position to the locked position, the open member is moved from the unlocked position to the locked position with the lock lever engaging with the open member, and when the lock lever is moved from the locked position to the unlocked position, the open member can relatively movable to the lock lever.

2. A door lock device, according to claim 2, wherein the biasing member for biasing the open lever to the initial position form the operating position.

3. A door lock device, according to claim 1, further including a base, wherein the open lever is rotatably supported by a first rotational center relative to the base, the open member is rotatably supported by a second rotational center relative to the open lever, and the biasing member is a torsion spring supported by the first rotational center, in which one end is engaged with the base and the other end is engaged with an engaging portion provided on the open member so as to be located differently from the second rotational center.

4. A door lock device, according to claim 1, wherein the lock lever includes a guide arm connecting the link member and the lock lever in order to when the lock lever is moved from the locked position to the unlocked position.

5. A door lock device, according to claim 1, wherein the open member includes a link member receiving an operation force from the open lever and engageable with the lift lever, and an elastic member connecting the link member and the lock lever in order to when the lock lever is moved from the locked position to the unlocked position.
